(19) United States
(12) Patent Application Publication
(10) Pub. No.: US 2004/0244015 A1
(43) Pub. Date: Dec. 2, 2004

(54) Optical disk drive

(76) Inventors: Chikara Sekiguchi, Kanagawa (JP); Toyokazu Arai, Kanagawa (JP); Kiyofumi Sato, Kanagawa (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/792,710

(22) Filed: Mar. 5, 2004

(30) Foreign Application Priority Data
May 27, 2003 (JP) P.2003-148467

(51) Int. Cl. G11B 33/02

(52) U.S. Cl. 720/601

(57) ABSTRACT

An optical disk drive includes a first gear formed on a rotary shaft of a motor, a second gear meshing with the first gear, a third gear co-axially and integrally rotating with the second gear, a fourth gear meshing with the third gear, and a slider to which the fourth gear is mounted, and sliding in accordance with a rotation of the third gear. The third gear is press-fitted into a mating hole of the second gear. The second gear and the third gear slip at a press fitting portion one another when a torque having a predetermined value or greater is applied to the press fitting portion.

### BACKGROUND OF THE INVENTION

The present invention relates to a slide feed mechanism using a worm gear for converting a rotary motion to a linear motion so that an optical pickup in an optical disk drive, for example, makes a sliding movement.

A slide feed mechanism using a worm gear is known as one of the mechanisms for converting a rotary motion to a linear motion and used in various disk drives.

In optical disk drives such as CD and DVD drives, for example, slide feed mechanisms using worm gears have been employed as means for sliding optical pickups (OPU) diametrically from the inner to outer peripheries of optical disks inserted into the optical disk drives in order to read out information recorded on the optical disks such as CDs and DVDs.

A slide feed mechanism in an optical disk drive of the sort mentioned above normally includes a motor such as a DC motor and a stepping motor capable of rotating forwardly and reversely, a worm gear mounted to the rotary shaft of the motor, a wheel gear having an axis of rotation perpendicular to a rotation axis of the motor, and meshing with the worm gear, a small-diameter pinion gear rotating integrally with the wheel gear, a rack gear meshing with the pinion gear, and a slider moving in the axial direction of the motor along a guide rod to which the rack gear is mounted. An optical pickup is mounted to the slider and arranged so that when the motor is rotated forwardly or reversely, the optical pickup moves from the inner to outer peripheries or from the outer to inner peripheries of an optical disk.

In the slide feed mechanism above, an excessive load may be applied to the gear portion when the optical disk drive undergoes a shock from the outside and the slider attempts to move in a manner irrelevant to the operation of the slide feed mechanism under the influence of the shock. In such a case as that, gears, screws and the like used to constitute a deceleration mechanism are set readily releasable from engagement as a result of the shock delivered from the outside, so that the slider is released from the slide feed mechanism and made movable whereby to make escapable the load applied to the gear portion. Otherwise, gears, screws and the like are so arranged as to be prevented from being released from engagement, so that the gear portion is able to withstand the shock by increasing the strength of the gears, for example the secured gear portion is disclosed in JP-A-2003-123411.

In case that the gears are allowed to be released from meshing together when the shock delivered from the outside is applied to the slide feed mechanism of the optical disk drive. However, the slider released from the slide mechanism is caused to move very fast owing to the shock and then the optical pickup mounted to the slider may be affected a great shock when the slider is moved so fast.

Also, in case that the gears is configured so as not to be released from meshing together when the shock delivered from the outside is occurred, the load may be applied to the gear portion tends to become too great and particularly when a greater shock exceeding 100 G is applied to the gear portion, deformation and breakage of teeth of each gear occur, which could results in faulty operation.

### SUMMARY OF THE INVENTION

It is therefore an object of the present invention to provide an optical disk drive capable of preventing an excessive load from being applied to a gear portion without arranging that gears are released from meshing together when a shock is received from the outside.

In order to achieve the above object, according to the present invention, there is provided an optical disk drive, comprising:

a worm gear, formed on a rotary shaft of a motor;

a wheel gear, meshing with the worm gear;

a pinion gear, co-axially and integrally rotating with the wheel gear;

a rack gear, meshing with the pinion gear; and

a slider, to which the rack gear is mounted, and sliding in accordance with a rotation of the pinion gear,

wherein the pinion gear is press-fitted into a mating hole of the wheel gear; and

wherein the wheel gear and the pinion gear slip at a press fitting portion one another when a torque having a predetermined value or greater is applied to the press fitting portion.

Preferably, the pinion gear is formed as a component part separately from the wheel gear.

Preferably, a value of the at which a slippage at the press fitting portion is started is set in accordance with at least one of a dimension of a press-fitting part of the pinion gear which is press-fitted into the mating hole of the wheel gear and a dimension of the mating hole of the wheel gear.

Preferably, a protrusion is formed on at least one of an outer face of a press-fitting part of the pinion gear which is press-fitted into the mating hole of the wheel gear and an inner face of the mating hole of the wheel gear.

Preferably, an optical pickup is mounted to the slider.

In the above configurations, the pinion gear is caused to slip in the matching portion in which the pinion gear is fitted into the wheel gear, whereby the torque limiter function operates when a shock is delivered from the outside, so that the force (shock) applied to the pinion gear and the wheel gear is canceled when the slider is moved in a manner irrelevant to the operation of the slide feed mechanism.

As set forth above in detail, the slide feed mechanism of the optical disk drive according to the invention makes it possible to prevent an excessive load from being applied to the gear portion without arranging that the gears are released from meshing together when a shock is received from the outside.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of an optical disk drive equipped with a slide feed mechanism according to the invention;

FIG. 2 is a plan view showing a schematic construction of a mechanism unit with the slide feed mechanism arranged inside;

FIG. 3 is a plan view of the principal part of the slide feed mechanism;

FIG. 4 is a sectional view of the principal part of the slide feed mechanism; and

FIG. 5 is an exploded side view showing assembly structure of a pinion gear and a wheel gear.

### DETAILED DESCRIPTION OF THE PREFERRED EMBODIMENTS

A detailed description will now be given of a specific slide feed mechanism in an optical disk drive embodying the invention by reference to the drawings. Incidentally, the invention is applied to a slide feed mechanism for causing an optical pickup to make a sliding movement over the diametrical direction of an optical disk in the optical disk drive. However, the invention is needless to say not limited to the embodiment thereof shown by way of example hereinafter.

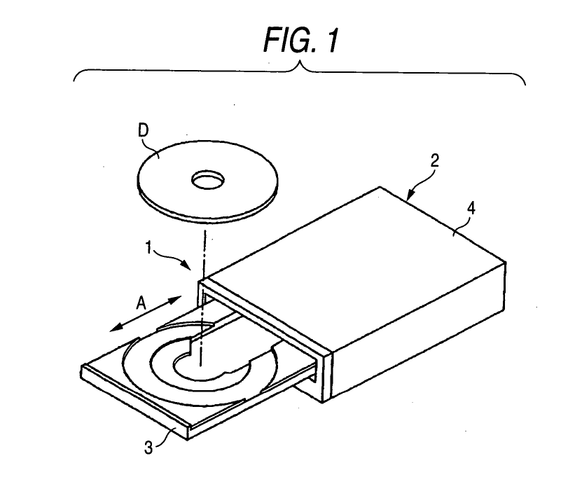

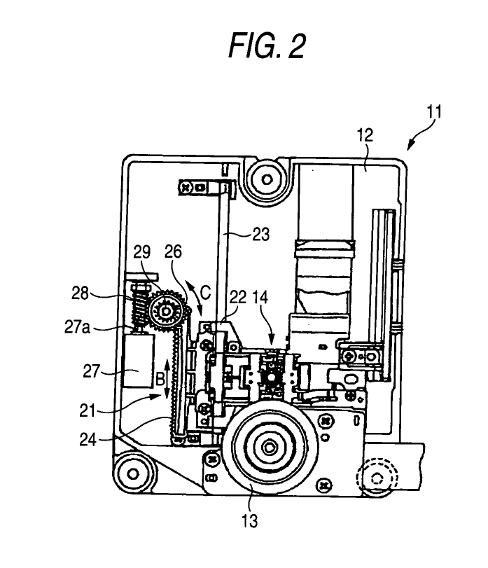

As shown in FIG. 1, an optical disk drive 1 includes a body 2 and a disk tray 3 for carrying an optical disk D inserted into and extracted from the body 2 in a direction of an arrow A in FIG. 1. The body 2 contains a mechanism unit 11 in a casing 4 as an outer casing of the body 2. The mechanism unit 11 has mechanisms arranged as shown in FIG. 2 for rotating the optical disk D on the disk tray 3, reading information recorded thereon and so forth.

The mechanism unit 11 includes a turntable 13 on which an optical disk D is mounted, an optical pickup 14 for used in the playback of or recording/playback of the optical disk D, and a slide feed mechanism 21 for sliding the optical pickup 14. These component parts of the mechanism unit 11 are arranged on a unit base 12 formed of hard resin, for example.

The turntable 13 is a discal member driven to rotate by a spindle motor (not shown). The turntable 13 is a chucking mechanism for fixedly positioning the optical disk D carried on the disk tray 3. In the optical disk drive 1, the optical disk D fixedly positioned on the turntable 13 is rotated together with the turntable 13 by the spindle motor.

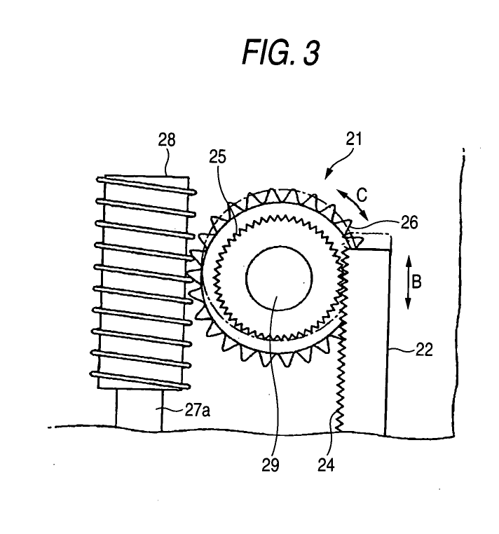

The slide feed mechanism 21 operates to slide the optical pickup 14 in the direction of an arrow B over the diametrical direction of the optical disk D carried by the disk tray 3. The slide feed mechanism 21 includes a slider 22 to which the optical pickup 14 as a device to be driven is mounted, a guide rod 23 for guiding the slider 22 in its moving direction, a rack gear 24 mounted to the one side of the slider 22, a pinion gear 25 (shown in FIG. 3) which is a spur gear meshing with the rack gear 24, a wheel gear 26 which is a helical gear holding the rotary shaft in common with the pinion gear 25 and rotating integrally with the pinion gear 25, and a worm gear 28 meshing with the wheel gear 26 and mounted to the rotary shaft 27a of a motor 27. A rotation axis of the rotary shaft 27a is perpendicular to a rotation axis of the wheel gear 26.

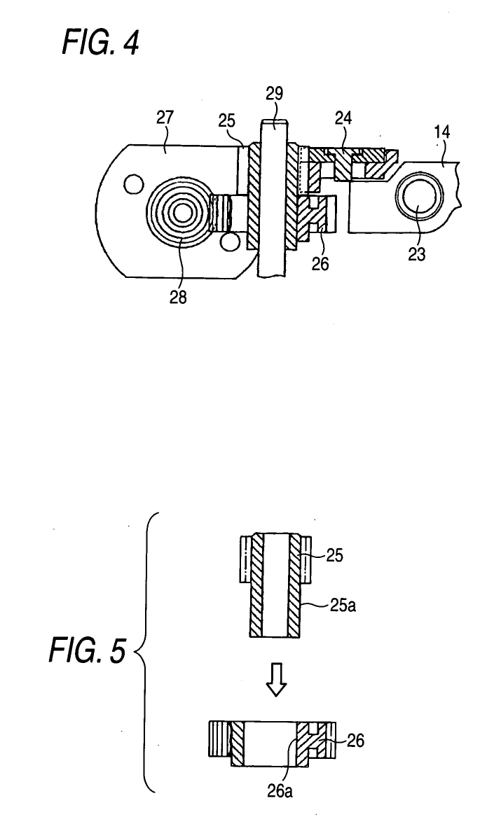

As shown in FIGS. 3 and 4, the wheel gear 26 meshing with the worm gear 28 and the pinion gear 25 rotating integrally with the wheel gear 26 rotate in the direction of an arrow C when the worm gear 28 mounted to the rotary shaft 27a is rotated by driving the motor 27 to rotate the rotary shaft 27a. When the pinion gear 25 is thus rotated, the slider fitted with the rack gear 24 meshing with the pinion gear 25 makes a sliding movement in the direction of the arrow B, so that the optical pickup 14 is moved in the diametrical direction of the optical disk D.

As shown in FIG. 5, the pinion gear 25 and the wheel gear 26 are molded as separate parts and assembled together by lightly press-fitting the cylindrical base end portion 25a of the pinion gear 25 into the mating hole 26a of the wheel gear 26. It is thus possible to provide a torque limiter function for causing the pinion gear 25 to slip in the matching portion when a high-G shock is delivered to the gear portion.

More specifically, since the pinion gear 25 and the wheel gear 26 are solely joined together, the base end portion 25a of the pinion gear 25 is caused to slip within the mating hole 26a of the wheel gear 26 when a force exceeding the fixing force given by the press-fitting is applied. Consequently, slippage occurs in the matching portion where the pinion gear 25 and the wheel gear 26 are joined together only when greater torque owning to a specific great shock is applied to the gear portion, so that the gear teeth are prevented from being broken in portions where the pinion gear 25 meshes with the rack gear 24 and where the wheel gear 26 meshes with the worm gear 28. During the normal time (during the operation of the slide mechanism), the upper gear and the lower gear (the pinion gear 25 and the wheel gear 26) are rotated integrally without any slippage in the matching portion and the rotation of the worm gear 28 is transmitted to the rack gear 24.

In the structure above, the external diameter dimension of the base end portion 25a and the internal diameter dimension of the mating hole 26a of the wheel gear 26, for example, are defined in definite dimensions when the base end portion 25a and the mating hole 26a are finished up, whereby the torque limiter function is made performable; that is, torque with which the slippage is started in the matching portion is adjustable. In case that the external diameter dimension of the base end portion 25a of the pinion gear 25 is designed slightly large, a greater press-fitting force is required, so that the torque value at which the slippage is started in the matching portion increases. In case that the external diameter dimension of the base end portion 25a of the pinion gear 25 is designed slightly small, the torque value at which the slippage is started in the matching portion also decreases conversely. Therefore, the external diameter dimension of the base end portion 25a of the pinion gear 25 may be designed according to the intensity of an estimated shock and so on. In case that the external diameter dimension of the base end portion 25a of the pinion gear 25 is set to 4.5 mm and the internal diameter dimension of the mating hole 26a of the wheel gear 26 to 4.5 mm with errors between the external and internal diameter dimensions ranging from 125 μm to 145 μm, for example, such slippage occurs in the matching portion when a shock of 80 G is delivered to the optical pickup 14 for about 8 msec.

Further, semicircular or triangular protrusions are formed at predetermined intervals on the inner face of the mating hole 26a of the wheel gear 26, for example, and the base end portion 25a of the pinion gear 25 is press-fitted in while the protrusions are being squashed, whereby not only the press-fitting force but also the torque value at which the slippage is started in the matching portion can be reduced. Otherwise, the press-fitting force and the torque value at which the slippage is started in the matching portion can also be reduced by forming similar protrusions on the outer face of the base end portion 25a of the pinion gear 25.

With the arrangement above, the exertion of impact force is canceled by the torque limiter function between the pinion gear 25 and the wheel gear 26 even when the force of moving the slider 22 in the direction of the double headed arrow B is applied by the delivery of the shock to the optical disk drive 1 from the outside in a manner irrelevant to the operation of the slide feed mechanism 21. Consequently, faulty operation is prevented without deformation and breakage of teeth caused by the excessive load applied to each gear.

What is claimed is:

1. An optical disk drive, comprising:
a first gear, formed on a rotary shaft of a motor;
a second gear, meshing with the first gear;
a third gear, co-axially and integrally rotating with the second gear;
a fourth gear, meshing with the third gear; and
a slider, to which the fourth gear is mounted, and sliding in accordance with a rotation of the third gear,
wherein the third gear is press-fitted into a mating hole of the second gear; and
wherein the second gear and the third gear slip at a press fitting portion one another when a torque having a predetermined value or greater is applied to the press fitting portion.

2. The optical disk drive as set forth in claim 1, wherein the third gear is formed as a component part separately from the second gear.

3. The optical disk drive as set forth in claim 1, wherein a value of the at which a slippage at the press fitting portion is started is set in accordance with at least one of a dimension of a press-fitting part of the third gear which is press-fitted into the mating hole of the second gear and a dimension of the mating hole of the second gear.

4. The optical disk drive as set forth in claim 1, wherein a protrusion is formed on at least one of an outer face of a press-fitting part of the third gear which is press-fitted into the mating hole of the second gear and an inner face of the mating hole of the second gear.

5. The optical disk drive as set forth in claim 1, wherein an optical pickup is mounted to the slider.
